(19) United States
(12) Patent Application Publication
(10) Pub. No.: US 2009/0157760 A1
(43) Pub. Date: Jun. 18, 2009

(54) Management system, management method and control program

(76) Inventors: Yutaka Yasunaga, Tokyo (JP); Kazuyoshi Tanaka, Tokyo (JP)

Correspondence Address: BUCHANAN, INGERSOLL & ROONEY PC, POST OFFICE BOX 1404, ALEXANDRIA, VA, 22313-1404, US

(21) Appl. No.: 12/314,764

(22) Filed: Dec. 16, 2008

(30) Foreign Application Priority Data
Dec. 18, 2007 (JP) JP2007-325647

(51) Int. Cl. G06F 17/30

(52) U.S. Cl. 707/200; 707/E17.005

(57) ABSTRACT

A management system in which at least one management apparatus and at least one apparatus to be managed are connected via a management server, wherein the management server comprising:
an information acquisition section for acquiring from the management apparatus, a host ID which discerns the management apparatus, and from the apparatus to be managed, acquiring a device ID which discerns the apparatus to be managed, a host ID of the management apparatus managing the apparatus to be managed, and an apparatus information which indicates a status of the apparatus to be managed;
a memory section for memorizing the apparatus information in a database; and
a storage control section for creating a plurality of hierarchies structured with upper and lower hierarchies each other in the database, and saves the apparatus information into a lower hierarchy based on the host ID and the device ID acquired from the management apparatus.

### RELATED APPLICATION

This application is based on Japanese Patent Application Publication No. 2007-325647, which was filed to Japan Patent Office on Dec. 18, 2007, and all the contents of this application shall be incorporated here by reference.

### TECHNICAL FIELD

A present invention relates to a control program, which operates by a management system, which includes a management server that connects a management apparatus and an apparatus to be managed, a management method and the management server.

### BACKGROUND

A copying machine and a MFP (Multi Function Peripheral)(these are hereafter generically called an image forming apparatus), which include a copy function, a facsimile function, a printer function and a scanner function, have popularized. Since this image forming apparatus has a high operating ratio, has many expendable parts- and needs to perform maintenance and check periodically, the image forming apparatus and the management apparatus are connected via communication network. The management apparatus acquires a printing number-of-sheets value of each size of form (counter value), defect information, such as jam, a toner residual quantity, a scanner counter value and information regarding the image forming apparatus of a firmware program version (hereafter, called apparatus information) from the image forming apparatus. The image forming apparatus is managed based on the apparatus information.

When there is a large number of the image forming apparatuses and when managing the image forming apparatus for every sales company, a method of providing the apparatus information of the image forming apparatus being a managing subject of the apparatus to be managed to each management apparatus by installing a management server between the management apparatus and the image forming apparatus and storing the apparatus information of all the image forming apparatus in this management server is used.

As an example of such management system, Japanese Patent Application Publication No. 2006-340239 discloses a configuration that re-determines whether the apparatus discernment is registered in the database after it is determined that an acquired apparatus discernment is not registered in the database after the central control system acquires the apparatus discernment notified from a device and responds in order to have a device from which a notification was transmitted perform a notification of the apparatus information corresponding to an acquisition of the apparatus discernment in the management system, which includes the central control system (the management server) between a sales company side system and a group of the image forming apparatuses of a customer side.

In a management system disclosed in Japanese Patent Application Publication No. 2006-340239, collectively performing a central control of a plurality of the image forming apparatuses is made possible by storing the apparatus information of the image forming apparatus in the database of a central control system. However, since a structure of the database is one hierarchy, and the apparatus information of the image forming apparatus of managing subject of each sales company and the apparatus information of the image forming apparatus of non-managing subject are intermingled and stored in the database, there was a problem that a management became complicated.

A method of providing the management server for every managing subject (for example, for every sales company) is also considered for the above-mentioned problem. However, in this method, a problem of cost of building the management server and cost of maintenance become high occurs.

Making the management less complicated is possible by having information of every managing subject to one element of the database and displaying only the apparatus information for the managing subject. However, since the management server is required to confirm and determine the element of all registered apparatus information, a problem of a management server load becoming large occurs.

In a management system disclosed in Japanese Patent Application Publication No. 2006-340239, since the image forming apparatus was required to wait for the response from the central control system when the image forming apparatus accesses the central control system, there was a problem that it took time until series of operations (for example, registering operation) has finished.

### SUMMARY

The aspects of the present invention are any one of the computer readable storage mediums and the image forming apparatus described as follows.
(1) According to a management system reflecting an aspect of the present invention, a management system in which at least one management apparatus and at least one apparatus to be managed are connected via a management server, wherein the management server comprising:

an information acquisition section for acquiring from the management apparatus, a host ID which discerns the management apparatus, and from the apparatus to be managed, acquiring a device ID which discerns the apparatus to be managed, a host ID of the management apparatus managing the apparatus to be managed, and an apparatus information which indicates a status of the apparatus to be managed;

a memory section for memorizing the apparatus information in a database; and

a storage control section for creating a plurality of hierarchies structured with upper and lower hierarchies each other in the database, and saves the apparatus information into a lower hierarchy based on the host ID and the device ID acquired from the management apparatus.
(2) According to a management system reflecting an aspect of the present invention, a management system in which at least one management apparatus and at least one apparatus to be managed are connected via a management server, wherein the management server comprising:

an information acquisition section for acquiring from the management apparatus, a host ID which discerns the management apparatus and a device ID which discerns an apparatus to be managed which the management apparatus manages, and from the apparatus to be managed, acquiring a device ID which discerns the apparatus to be managed, a host ID of the management apparatus managing the apparatus to be managed, and an apparatus information which indicates a status of the apparatus to be managed;

a memory section for memorizing the apparatus information in a database; and

a storage control section for creating a plurality of hierarchies structured with upper and lower hierarchies each other in the database based on the host ID and the device ID acquired from the management apparatus and saves the apparatus information into a lower hierarchy.
(3) According to a management method reflecting another aspect of the present invention, a management method for a management system in which at least one management apparatus and at least one apparatus to be managed are connected via a management server,

wherein the management method comprising:

transmitting a host ID which discerns the management apparatus from the management apparatus to the management server,

creating a first hierarchies based on the host ID acquired from the management apparatus into the database on the management server,

transmitting a device ID which discerns the apparatus to be managed, a host ID of the management apparatus managing the apparatus to be managed, and a apparatus information which indicates a status of the apparatus to be managed from the apparatus to be managed to the management server,

creating a second hierarchy which belongs to the first hierarchy relating to the host ID based on the host ID and device ID acquired from the apparatus to be managed, and saving the apparatus information into the second hierarchy on the management server.
(4) According to a management method reflecting another aspect of the present invention, a management method for a management system in which at least one management apparatus and at least one apparatus to be managed are connected via a management server,

wherein the management method comprising:

transmitting a host ID which discerns the management apparatus and a device ID which discerns the apparatus to be managed that is managed by the management apparatus, from the management apparatus to the management server,

creating a first hierarchies based on the host ID acquired from the management apparatus,

creating a second hierarchy which belongs to the first hierarchy relating to the host ID based on the host ID and device ID acquired from the management apparatus on the management server,

transmitting the device ID which discerns the apparatus to be managed, the host ID of the management apparatus managing the apparatus to be managed, and an apparatus information which indicates a status of the apparatus to be managed from the apparatus to be managed to the management server, and

saving the apparatus information into the second hierarchy which belongs to the first hierarchy relating to the host ID on the management server.
(5) According to a computer readable recording medium reflecting another aspect of the present invention, a computer readable recording medium storing a program which causes a management server which is connected to at least one management apparatus and at least one apparatus to be managed,

acquiring from the management apparatus, a host ID which discerns the management apparatus,

acquiring from the apparatus to be managed, a device ID which discerns the apparatus to be managed, a host ID of the management apparatus managing the apparatus to be managed, and an apparatus information which indicates a status of the apparatus to be managed,

creating a plurality of hierarchies structured with upper and lower hierarchies each other in the database based on the host ID acquired from the management apparatus and the device ID acquired from the apparatus to be managed, and

saving the apparatus information into a lower hierarchy.
(6) According to a computer readable recording medium reflecting another aspect of the present invention, a computer readable recording medium storing a program which causes a management server which is connected to at least one management apparatus and at least one apparatus to be managed,

acquiring from the management apparatus, a host ID which discerns the management apparatus and a device ID which discerns an apparatus to be managed that is managed by the management apparatus,

acquiring from the apparatus to be managed, a device ID which discerns the apparatus to be managed, a host ID of the management apparatus managing the apparatus to be managed, and an apparatus information which indicates a status of the apparatus to be managed,

creating a plurality of hierarchies structured with upper and lower hierarchies each other in the database based on the host ID and the device ID acquired from the management apparatus, and

saving the apparatus information into a lower hierarchy.

### BRIEF DESCRIPTION OF THE DRAWINGS

FIG. 1 illustrates a figure schematically showing a configuration of a management system related to a first embodiment of the present invention.

FIG. 2 illustrates a figure schematically showing other configuration of the management system related to the first embodiment of the present invention.

FIG. 3 illustrates a block diagram showing a configuration of a management apparatus related to the first embodiment of the present invention.

FIG. 4 illustrates a block diagram showing a configuration of a management server related to the first embodiment of the present invention.

FIG. 5 illustrates a block diagram showing a configuration of an image forming apparatus related to the first embodiment of the present invention.

FIG. 6 illustrates a flow chart showing a registration procedure of the management apparatus related to the first embodiment of the present invention.

FIG. 7 illustrates a flow chart showing a registration procedure of the image forming apparatus and a storing procedure of apparatus information related to the first embodiment of the present invention.

FIG. 8 illustrates a flow chart showing the registration procedure of the management apparatus and the image forming apparatus related to a second embodiment of the present invention.

FIG. 9 illustrates a flow chart showing the storing procedure of the apparatus information related to the second embodiment of the present invention.

FIG. 10 illustrates a flow chart showing a perusal procedure of the apparatus information related to the second embodiment of the present invention.

### DESCRIPTION OF THE PREFERRED EMBODIMENT

In a preferred embodiment, the present invention is to provide a management server to which one or a plurality of management apparatuses and one or a plurality of image forming apparatuses are connected to efficiently manage a plurality of image forming apparatuses by providing an information acquisition section for acquiring a host ID, or host ID and device ID from a management apparatus, and for acquiring a host ID, a device ID and apparatus information from the image forming apparatus, a database for storing the apparatus information, and a storage control section for storing apparatus information of the image forming apparatus into a directory of every image forming apparatus by creating the directory for every image forming apparatus under the directory of every image forming apparatus based on a host ID and a device ID from the image forming apparatus, creating a directory of every management apparatus based on a host ID and a device ID from the management apparatus and creating directory of every image forming apparatus after creating a directory for every management apparatus based on the host ID from the management apparatus.

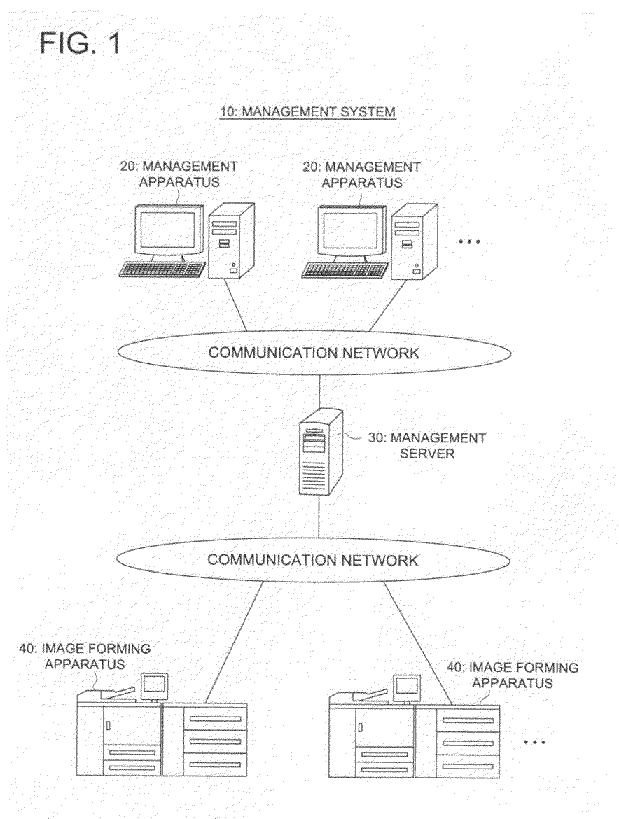

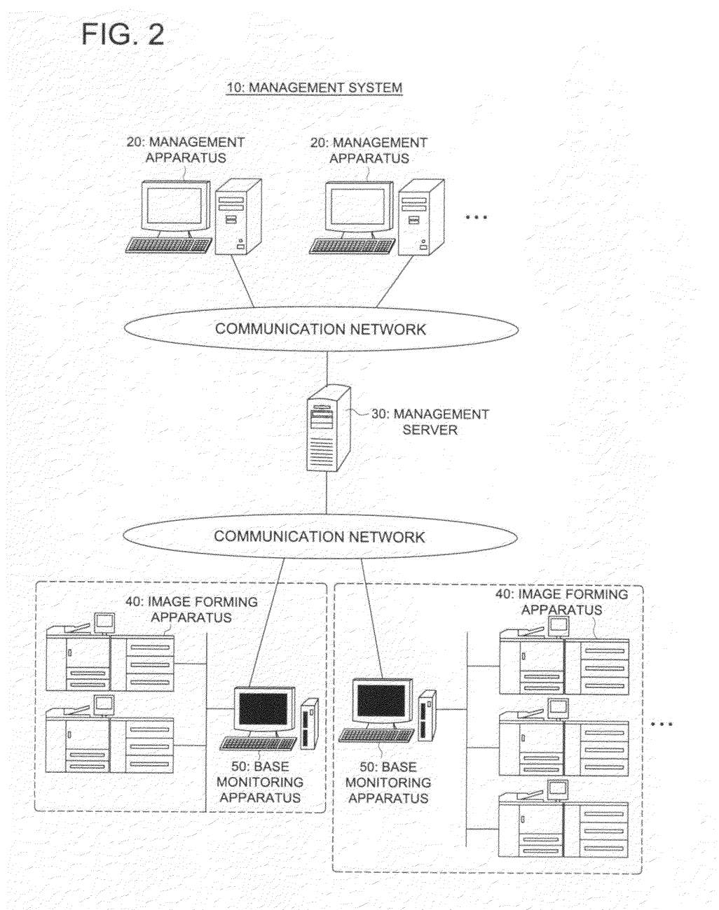

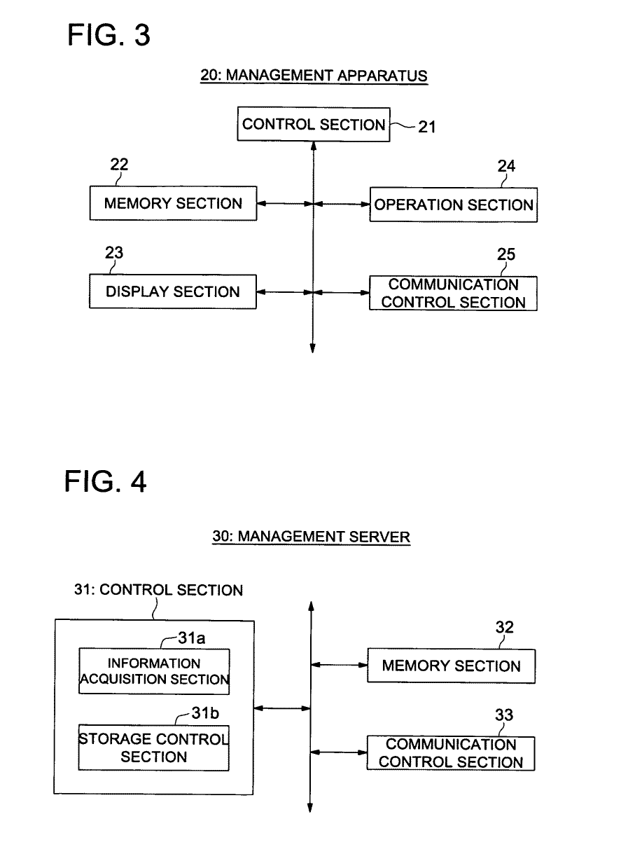

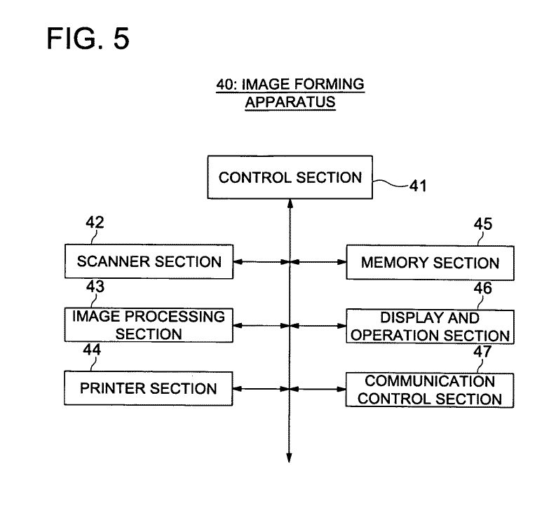

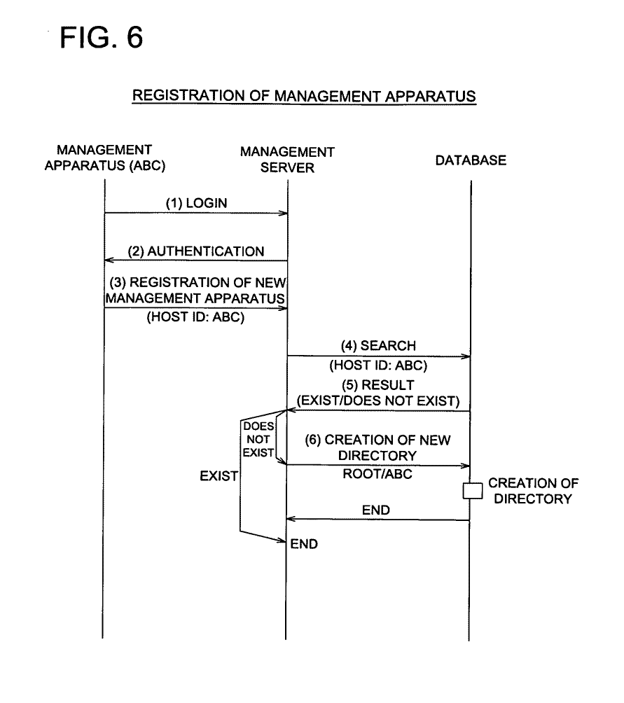

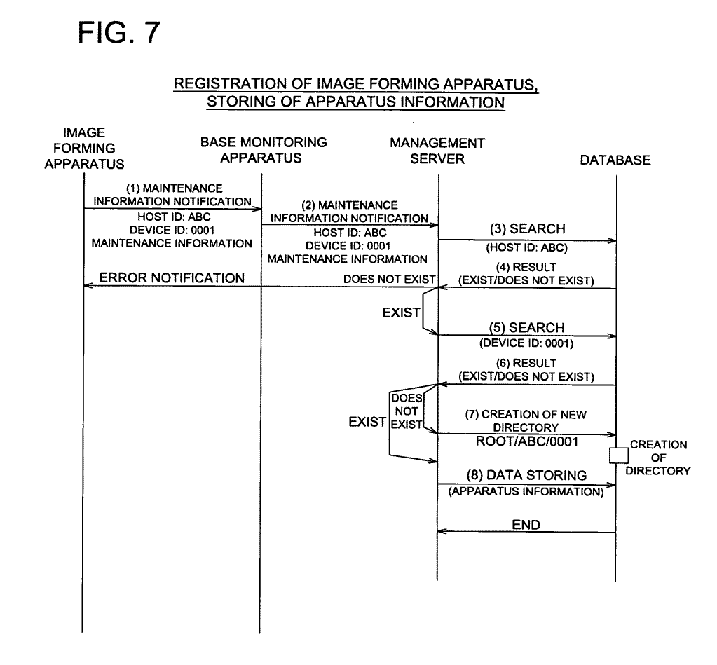

A management system, a management method, and a control program related to the first embodiment of the present invention will be explained with reference to FIGS. 1-7. FIGS. 1 and 2 illustrate figures schematically showing a configuration of the management system of this embodiment of the present invention. FIG. 3 illustrates a block diagram showing a configuration of a management apparatus of this embodiment of the present invention. FIG. 4 illustrates a block diagram showing a configuration of a management server of this embodiment of the present invention. FIG. 5 illustrates a block diagram showing a configuration of an image forming apparatus of this embodiment of the present invention. FIG. 6 illustrates a flow chart showing a registration procedure of the management apparatus. FIG. 7 is a flow chart showing a registration procedure of the image forming apparatus and a storing procedure of apparatus information.

As shown in FIG. 1, a management system 10 of this embodiment of the present invention includes a management apparatus 20 installed in a managing side (for example, each sales company), an apparatus to be managed installed in a side to be managed (for example each user or each company) (considered as an image forming apparatus 40 in this embodiment of the present invention), and a management server 30 installed in between the management apparatus 20 and the image forming apparatus 40. These are mutually connected via communication networks, such as the Internet.

FIG. 1 illustrates a basic configuration of the management system 10 of this embodiment of the present invention. Quantity and connection form of the management apparatus 20 and the image forming apparatus 40 are arbitrary. In FIG. 1, only the management apparatus 20 is provided in the managing side. However, a configuration in which a server and a database are provided in addition to the management apparatus 20 may be considered. Although only the image forming apparatus 40 is provided in the managed side in FIG. 1, a configuration in which a base monitoring apparatus 50 for supervising a plurality of the image forming apparatus 40 is provided may be considered as shown in FIG. 2. Hereafter, each configuration factor will be described in detail.

### [Management Apparatus]

The management apparatus 20 includes a control section 21, a memory section 22, a display section 23, an operation section 24, and a communication control section 25 as shown in FIG. 3.

The control section 21 is configured by CPU (Central Processing Unit), ROM (Read Only Memory), and RAM (Random Access Memory). CPU reads a various programs memorized in ROM, and extracts to RAM. Then, CPU controls operation of each section of the management apparatus 20 according to an extracted program by an operation of the operation section 24.

The memory section 22 is configured by a flash memory and hard disk, and memorizes various data. Particularly in this embodiment of the present invention, the memory section 22 memorizes information for discerning an apparatus itself (a serial number of the machine, MAC (Media Access Control) information, and information set up arbitrarily are hereafter called a host ID). In addition to that, the memory section 22 memorizes information related to the image forming apparatus 40 being a managing subject, which has been acquired from the management server 30 (A value for a number of printing sheets for every sheet size (counter value), JAM defect information, a toner residual quantity, a scanner counter value, and a firmware program version are hereafter called apparatus information).

The display section 23 is configured by a LCD (Liquid Crystal Display), and an organic electroluminescence display. The display section 23 displays a screen for registering the management apparatus 20 to the management server 30 and a screen of a web site, which the management server 30 provides.

The operation section 24 is configured by a keyboard and a mouse. The operation section 24 performs an operation for registering the management apparatus 20 to the management server 30, and an operation for perusing and acquiring the apparatus information of the image forming apparatus 40 by using the web site screen provided by the management server 30.

The communication control section 25 is configured by NIC (Network Interface Card) and a modem, and connects the management apparatus 20 to a communication network. Particularly in this embodiment of the present invention, the communication control section 25 transmits the host ID to the management server 30, and controls access to the web site provided by the management server 30.

### [Management Server]

The management server 30 includes a control section 31, a memory section 32, and a communication control section 33 as shown in FIG. 4. This management server 30 can create a directory for storing the apparatus information acquired from the image forming apparatus 40. A HTTP (Hyper Text Transfer Protocol) server, and, especially, a WebDAV (Distributed Authoring and Versioning protocol for the WWW) server are preferable for the management server 30.

The control section 31 is configured by CPU, ROM, and RAM. CPU reads various programs memorized by ROM and extracts to RAM. Then, CPU controls the operation of each section of the management server 30 according to the extracted program. The control section 31 functions as an information acquisition section 31a and a storage control section 31b.

The information acquisition section 31a acquires the host ID from the management apparatus. In addition to that, the information acquisition section 31a acquires the host ID and the information that discerns the image forming apparatus 40 (Information set up at the time of manufacture, such as a mechanical serial number or MAC information, is hereafter called device ID) and the apparatus information of this image forming apparatus 40 from the image forming apparatus 40. The storage control section 31b searches the host ID and the device ID from the memory section 32 (database), creates a multi-tiered hierarchy directory to the memory section 32 based on the host ID and the device ID, and stores the apparatus information in a device ID directory.

The information acquisition section 31a and the storage control section 31b may be configured as a hardware, may be configured as a control program for functioning the information acquisition section 31a and the storage control section as a computer, or may be configured to operate the control program on the control section 31.

The memory section 32 is configured by a flash memory and hard disk, and functions as a database, which memorizes various data. Particularly in this embodiment of the present invention, the memory section 32 memorizes the apparatus information with the multi-tiered hierarchy created based on the host ID and the device ID. This memory section 32 may be provided in the management server 30, and may be separated from the management server 30.

The communication control section 33 is configured by NIC and a modem, and connects the management server 30 to the communication network. Particularly in this embodiment of the present invention, a web site for the management apparatus 20 to peruse and acquire the apparatus information of the image forming apparatus 40 is provided.

Although the management server 30 is configured so as to include the control section 31, the memory section 32, and the communication control section 33 in FIG. 4, a display section and an operation section for an operator to operate may be provided as well.

### [Image Forming Apparatus]

The image forming apparatus 40 includes a control section 41, a scanner section 42, an image processing section 43, a printer section 44, a memory section 45, a display and operation section 46 and a communication control section 47 as shown in FIG. 5.

The control section 41 is configured by CPU, ROM, and RAM. CPU reads the various programs memorized by ROM, and extracts to RAM by an operation of the display and operation section 46. Then, CPU controls an operation of each section of the image forming apparatus 40, and manages a state of each section according to the extracted program.

The scanner section 42 reads information recorded on a document, and is configured by a light source for scanning the document, a CCD (Charge Coupled Devices) for converting a light reflected on the document into an electric signal, and an A/D converter for A/D converting the electric signal.

The image processing section 43 performs a various image processing, such as expansion/reduction, rotation, frequency conversion, color conversion to YMCK data from RGB data and tone correction, to an image read by the scanner section 42 (hereafter, called a scanned image).

The printer section 44 includes an image forming section for forming an image to be printed on a transfer paper, a transfer section for transferring a formed image onto the transfer paper, a fixing section for fixing a transferred image, a conveyance section for conveying the transfer paper, a cleaning section for cleaning the image forming section, the transfer section and fixing section. The printer section 44 forms the image and outputs on the transfer paper with an electronic photographic method based on an inputted data. The printer section 44 is also provided with a method for monitoring the toner residual quantity and a counter for counting a printing number of sheets of the transfer paper of each size of form. Then, the printer section 44 transmits the apparatus information such as the toner residual quantity and a counter value to the control section 41.

The memory section 45 is configured by a flash memory and a hard disk, and memorizes various data and setting conditions. Particularly in this embodiment of the present invention, the memory section 45 memorizes the device ID of the apparatus information of each section and of the apparatus itself, and the host ID of management apparatus 20.

The display and operation section 46 is configured by having an operation section of a pressure-sensitive type (touch panel) onto which a transparent electrode is arranged in lattice shape on the liquid crystal display or the organic electroluminescence display. The display and operation section 46 detects XY coordinates of a emphasis pushed with fingers and a touch pen in a voltage value, and outputs to the control section 41 by making a detected position signal into a manipulate signal.

The communication control section 47 is configured by NIC and a modem, and connects the image forming apparatus 40 to the communication network. Particularly in this embodiment of the present invention, the communication control section 47 controls a transmission of the host ID, the device ID and the apparatus information to the management server 30.

In FIG. 5, the image forming apparatus 40 is considered as a multi function peripheral, which includes the scanner section 42, the image processing section 43 and the printer section 44. However, the image forming apparatus 40 may be a scanner, a printer and a copy machine. Further, the image forming apparatus 40 may be configured to have an finishing apparatus, which performs ADF (Auto Document Feeder), a hole punch, a staple and a binding.

Hereafter, a procedure of registering the management apparatus 20 to the management server 30 using the management system 10 of the above-mentioned configuration will be described with reference to the flow chart of FIG. 6. The management server 30 and the memory section 32 (database) are shown separately in FIG. 6 (FIGS. 7-10 are also the same) in order to make a database process easy to understand.

First, in (1), the control section 21 of the management apparatus 20 accesses the management server 30 using the communication control section 25, transmits a predetermined ID and password and logs into the management server 30.

Next, in (2), the management server 30 compares the ID and password transmitted from the management apparatus 20 to the ID and the password memorized by the memory section 32. Then, the management server 30 authenticates the management apparatus 20 and notifies an authentication result to the management apparatus 20.

Next, in (3), the authenticated management apparatus 20 transmits the host ID (here, referred to as “ABC”), which is memorized by the memory section 22 in advance, or is inputted from the operation section 24, to the management server 30. Then, the authenticated management apparatus 20 performs a registration request to the management server 30. Although a transmission method of the host ID is not particularly limited, for example, in a case when the management server 30 is a HTTP server (especially WebDAV server), it may be arranged so that a web screen is created in the management server 30 side, and is displayed by a web browser of the management apparatus 20 so that the host ID can be written in onto the web screen.

Next, in (4), the information acquisition section 31a of the management server 30 acquires the transmitted host ID, and the storage control section 31b performs a search of the host ID “ABC” to the memory section 32 (database).

In a case when the host ID “ABC” is found on the database as a search result of (5), a process ends. On the other hand, in a case when the host ID “ABC” is not found on the database as a search result of (5), the storage control section 31b creates a directory of “ABC” in (6). Then, the process ends.

Next, the registration of the image forming apparatus and the storing procedure of the apparatus information are explained with reference to the flow chart of FIG. 7.

First, when a service personnel sets up the image forming apparatus 40 to a user's site, the service personnel sets up information (IP address) of a base monitoring apparatus 50 to the image forming apparatus 40 by operating the display and operation section 46 when there is information of the management server 30 (for example, URL (Uniform Resource Locator) and IP (Internet Protocol) address), the host ID of the management apparatus 20 (the above-mentioned “ABC”), and the base monitoring apparatus 50.

Next, in (1) and (2), the control section 41 of the image forming apparatus 40 acquires the apparatus information from each section, and notifies the host ID, the device ID and the apparatus information to the management server 30 (or the base monitoring apparatus 50) in a predetermined timing.

Next, in (3), the information acquisition section 31a of the management server 30 acquires the transmitted host ID, and the storage control section 31b performs a search of the host ID “ABC” to the memory section 32 (database).

In case when the host ID “ABC” is not found on the database as a search result of (4), a management is determined to be unprepared. Therefore, the control section 31 notifies an error to the image forming apparatus 40. On the other hand, in case when the host ID “ABC” is found on the database, the storage control section 31b performs a search of a device ID “0001” to the memory section 32 (database) in (5).

In case when the device ID “00011” is not found on the database as a search result of (6), the storage control section 31b creates a “0001” directory under an “ABC” directory to the database in (7).

After creating the directory in (7), or in case when the device ID “0001” is found on the database in (6), the storage control section 31b stores the apparatus information to ABC/0001 directory of the database, and the process ends after that in (8).

Thus, when the host ID is transmitted from the management apparatus 20, the storage control section 31b of the management server 30 creates the host ID directory to the memory section 32 (database). When the host ID, the device ID, and the apparatus information are transmitted from the image forming apparatus 40, the storage control section 31b of the management server 30 creates the device ID directory to a lower hierarchy of the host ID directory. Since the storage control section 31b of the management server 30 performs control for storing the apparatus information in the device ID directory, the apparatus information can be memorized in a form that is easy to manage. Thereby, a plurality of image forming apparatuses can be managed by the management apparatus 20 efficiently.

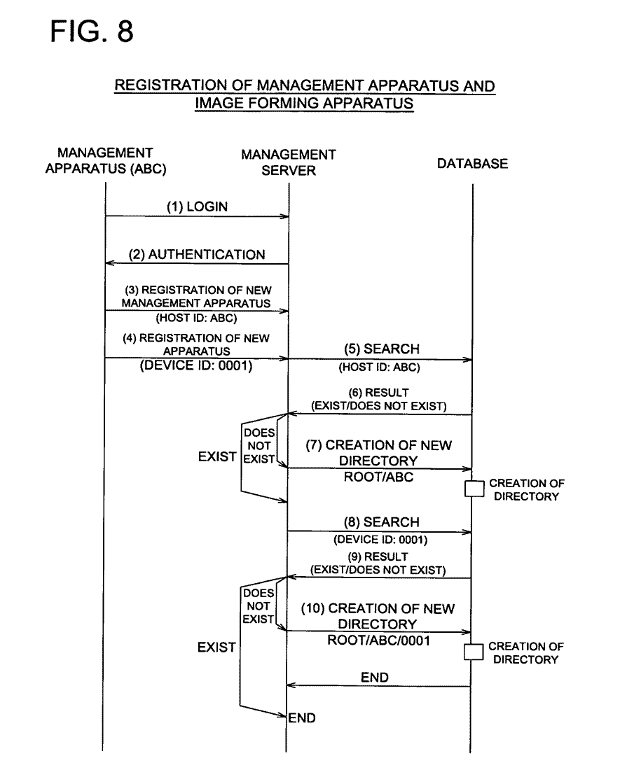

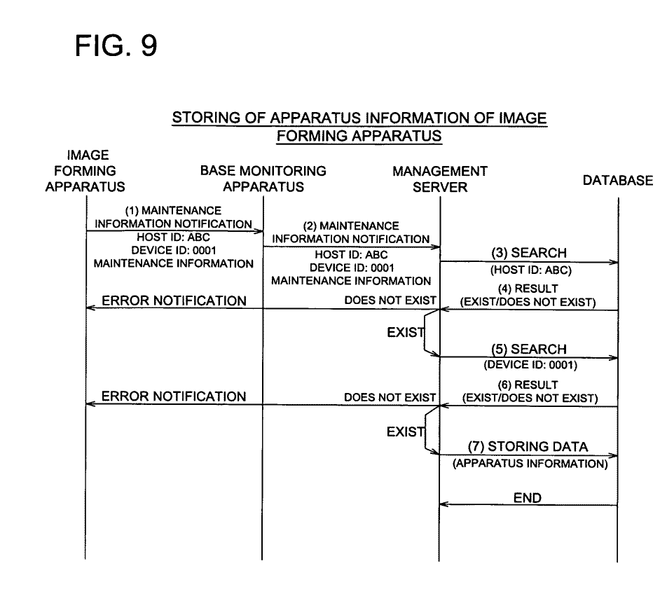

Next, a management system, a management method, and a control program related to a second embodiment of the present invention will be described with reference to FIGS. 8 and 9. FIG. 8 illustrates a flow chart showing a registration procedure of a management apparatus and an image forming apparatus. FIG. 9 illustrates a flow chart showing a procedure of storing apparatus information of the image forming apparatus.

In the above-mentioned first embodiment of the present invention, when the host ID is transmitted from the management apparatus 20, the storage control section 31b of the management server 30 creates the host ID directory to the memory section 32 (database). And when the device ID is transmitted from the image forming apparatus 40, the storage control section 31b of the management server 30 creates the device ID directory to the memory section 32 (database). However, in this configuration, a person who unjustly acquired the host ID is able to create the device ID directory in the database by transmitting the host ID and the device ID from the image forming apparatus 40. There is a possibility that the apparatus information may be unjustly or accidentally registered.

Accordingly, in the second embodiment of the present invention, the device ID directory is created in the database only with an instruction from the management apparatus 20 so that such impropriety will not occur. Hereafter, a procedure of registering the management apparatus 20 and the image forming apparatus 40 into the management server 30 will be described with reference to the flow chart of FIG. 8.

First, as the same as the first embodiment of the present invention, in (1), the control section 21 of the management apparatus 20 accesses the management server 30 using the communication control section 25, transmits a predetermined ID and password, and logs in to the management server 30.

Next, in (2), the management server 30 compares the ID and password transmitted from the management apparatus 20, and the ID and password memorized by the memory section 32. Then, the management server 30 authenticates the management apparatus 20, and notifies the authentication result to the management apparatus 20.

Next, in (3), the authenticated management apparatus 20 transmits the host ID (here, referred to as “ABC”), which is memorized by the memory section 22 or is inputted from the operation section 24, to the management server 30, and performs a registration request of the management apparatus 20 to the management server 30. With this, in (4), the device ID (here, referred to as “0001”), which is memorized by the memory section 22 in advance or is inputted from the operation section 24, is transmitted to the management server 30, and a registration request of the image forming apparatus 40 is performed to the management server 30. A transmission method of the host ID and the device ID is not particularly limited. However, in case when the management server 30 is a HTTP server (especially WebDAV server) as the same as the above mentioned first embodiment of the present invention, it may be arranged so that a web screen is created in the management server 30 side, and is displayed by a web browser of the management apparatus 20 so that the host ID can be written in onto the web screen.

Next, in (5), the information acquisition section 31a of the management server 30 acquires the host ID and device ID, which were transmitted. Then, the storage control section 31b performs a search of the host ID “ABC” to the memory section 32 (database).

In case when the host ID “ABC” is not found on the database as a search result of (6), the storage control section 31b creates a directory of “ABC” to the database in (7).

After the directory has been created in (7), or when the host ID “ABC” is found on the database in (6), the storage control section 31b performs a search of the device ID “0001” to the memory section 32 (database) in (8).

When the device ID “0001” is found on the database as a search result of (9), the process ends. When the device ID “0001” is not found on the database, the storage control section 31b creates a “0001” directory under the “ABC” directory to the database, and process ends after that.

Next, the storing procedure of the apparatus information of the image forming apparatus will be described with reference to the flow chart of FIG. 9.

First, as the same as the first embodiment of the present invention, when a service personnel sets up the image forming apparatus 40 to a user's site, the service personnel sets up information (IP address) of the management server 30 (for example, URL (Uniform Resource Locator) and IP (Internet Protocol) address)and the host ID of the management apparatus 20 (the above-mentioned “ABC”) by operating the display and operation section 46. When there is a base monitoring apparatus 50 the service personnel sets up information (IP address) of the base monitoring apparatus 50 to the image forming apparatus 40 by operating the display and operation section 46.

Next, in (1) and (2), the control section 41 of the image forming apparatus 40 acquires the apparatus information from each section, and notifies the host ID, the device ID, the apparatus information to the management server 30 (or the base monitoring apparatus 50) at a predetermined timing.

Next, in (3), the information acquisition section 31a of the management server 30 acquires the host ID and the device ID, which have been transmitted. The storage control section 31b performs a search of the host ID “ABC” to the memory section 32 (database).

When the host ID “ABC” is not found on a database as a search result of (4), the management is determined to be unprepared, and the control section 31 notifies an error to the image forming apparatus 40. On the other hand, when the host ID “ABC” is found on the database, the storage control section 31b performs a search of the device ID “00011” to the memory section 32 (database).

In case when the device ID “00011” is not found on the database as a search result of (6), the control section 30 determines that the management apparatus 20 is not considering the device ID as the managing subject and notifies an error to the image forming apparatus 40. On the other hand, when the device ID “00011” is found on the database as a search result of (6), the storage control section 31b stores the apparatus information to the ABC/0001 directory of the database, and the process ends after that.

Thus, when the host ID and the device ID are transmitted from the management apparatus 20, the storage control section 31b of the management server 30 creates the host ID directory and the device ID directory to the memory section 32 (database). When the host ID, the device ID and the apparatus information are transmitted from the image forming apparatus 40, since the storage control section 31b of the management server 30 performs a control for storing the apparatus information to the device ID directory, the apparatus information can be memorized in a form that is easy to be managed. Thereby, a plurality of image forming apparatuses 40 is efficiently manageable with the management apparatus 20. Since the host ID directory and the device ID directory are created by a request from the management apparatus 20, a problem of the device ID directory being unjustly or accidentally created in the database can be prevented.

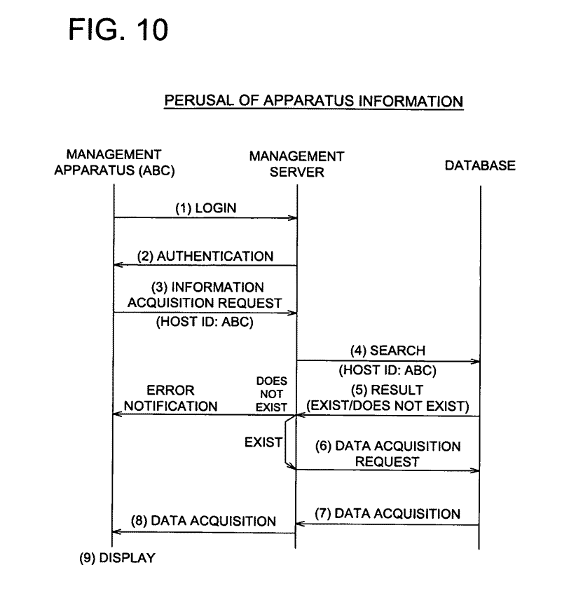

Next, a management system, a management method and a control program related to a third embodiment of the present invention will be described with reference to FIG. 10. FIG. 10 illustrates a flow chart showing a perusal procedure of the apparatus information of the third embodiment of the present invention.

The above-mentioned first and second embodiments of the present invention described the procedure of storing the apparatus information to the memory section 32 (database) of the management server 30. However, in the third embodiment of the present invention, a procedure of perusing the stored apparatus information will be described. Hereafter, the third embodiment of the present invention will be described with reference to the flow chart of FIG. 10.

First, as the same as the first and the second embodiments of the present invention, in (1), the control section 21 of the management apparatus 20 accesses the management server 30 using the communication control section 25, transmits predetermined ID and password, and logs in to the management server 30.

Next, in (2), the management server 30 compares the ID and the password transmitted from the management apparatus 20 with the ID and the password memorized by the memory section 32. Then, the management server 30 authenticates the management apparatus 20, and notifies the authentication result to the management apparatus 20.

Next, in (3), the authenticated management apparatus 20 transmits the host ID (here, referred to as “ABC”) inputted from the operation section 24 to the management server 30, and performs an acquisition request of information to the management server 30. A transmission method of the host ID is not particularly limited. However, as the same as the first and second embodiments of the present invention, when the management server 30 is the HTTP server (especially WebDAV server), it may be arranged so that a web screen is created in the management server 30 side, and is displayed by a web browser of the management apparatus 20 so that the host ID can be written in onto the web screen.

Next, in (4), the information acquisition section 31a of the management server 30 acquires the transmitted host ID. The storage control section 31b performs a search of the host ID “ABC” to the memory section 32 (database).

When the host ID “ABC” is not found on the database as a search result of (5), an error is notified to the management apparatus 20 and the process ends. When the host ID “ABC” is found on the database, the data in the “ABC” directory is acquired from the memory section 32 (database) in (6) and (7). Then the acquired data is transmitted to the management apparatus 20 in (8).

Next, in (9), the management apparatus 20 displays the data transmitted from the management server 30 onto the display section 23. A display form of this data is not particularly limited. The display form may be configured so that the transmitted data may be displayed on a screen created on the management apparatus 20 side. When the management server 30 is the HTTP server (especially WebDAV server), the display form may be configured so that a web screen on which the data in the “ABC” directory is created in the management server 30 side, is displayed by the web browser of the management apparatus 20, and performs a perusal and acquiring of the data.

A case of acquiring the data in the host ID directory was illustrated in the above-mentioned flow. However, acquiring the data in the device ID directory is also possible. In that case, an information acquisition request is performed by specifying the host ID and the device ID in (3). And the management server 30 may search the device ID directory under the host ID directory from the memory section 32 (database).

Each above-mentioned embodiment showed the case where the directory for every image forming apparatus was created under the directory for every management apparatus. However, the present invention is not limited to the above-mentioned embodiments, and two or more hierarchies may be created to the memory section 32 (database). For example, three or more hierarchies may be created, such as creating the directory for every group under the directory for every management apparatus, and creating the directory for every image forming apparatus under that.

Each above-mentioned embodiment showed the case where the apparatus information was stored. However, it is equally applicable to the case when storing arbitrary information required for managing the apparatus to be managed with the management apparatus 20. Each above-mentioned embodiment showed the case where the image forming apparatus 40 as the apparatus to be managed was managed. However, it is equally applicable to an arbitrary apparatus to be managed that is managed by the management apparatus 20.

According to the management system, the management method and the control program of each above-mentioned embodiment, at least one apparatuses to be managed are efficiently manageable.

The reason is that the management of the apparatus information can easily be performed by providing a management server between at least one management apparatuses and at least one apparatuses to be managed, and configuring the database of the management server into a multi-tiered hierarchy structure by providing

the information acquisition section for acquiring the host ID, the device ID and the apparatus information, and the storage control section for storing the apparatus information by creating a plurality of hierarchy, for example, by creating the directory for every apparatus to be managed under the directory for every management apparatus, based on the database for registering the apparatus information, the host ID and the device ID.

In the storage control section, the directory for every apparatus to be managed is created under the directory for every management apparatus based on the host ID and device ID, which were transmitted from the apparatus to be managed, and the directory for every apparatus to be managed is created under the directory for every management apparatus based on the host ID and device ID, which were transmitted from the management apparatus after the directory for every management apparatus was created in the database based on the host ID transmitted from the management apparatus. As described above, since a directory cannot be created in the database until the host ID is transmitted from the management apparatus, unjust registration and erroneous registration can be prevented.

What is claimed is:

1. A management system in which at least one management apparatus and at least one apparatus to be managed are connected via a management server, wherein the management server comprising:
an information acquisition section for acquiring from the management apparatus, a host ID which discerns the management apparatus, and from the apparatus to be managed, acquiring a device ID which discerns the apparatus to be managed, a host ID of the management apparatus managing the apparatus to be managed, and an apparatus information which indicates a status of the apparatus to be managed;
a memory section for memorizing the apparatus information in a database; and
a storage control section for creating a plurality of hierarchies structured with upper and lower hierarchies each other in the database, and saves the apparatus information into a lower hierarchy based on the host ID and the device ID acquired from the management apparatus.

2. The management system of claim 1,
wherein, the storage control section creates a first hierarchy based on the host ID acquired from the management apparatus, and
creates a second hierarchy which belongs to the first hierarchy relating to the host ID based on the device ID and the host ID acquired from the apparatus to be managed.

3. The management system of claim 2,
wherein, the storage control section creates the first hierarchy, when the host ID acquired from the management apparatus is not registered in the database.

4. The management system of claim 2,
wherein, the storage control section creates the second hierarchy which belongs to the first hierarchy relating to the host ID, when the device ID acquired from the management apparatus or the apparatus to be managed is not registered in the database.

5. A management system in which at least one management apparatus and at least one apparatus to be managed are connected via a management server, wherein the management server comprising:
an information acquisition section for acquiring from the management apparatus, a host ID which discerns the management apparatus and a device ID which discerns an apparatus to be managed which the management apparatus manages, and from the apparatus to be managed, acquiring a device ID which discerns the apparatus to be managed, a host ID of the management apparatus managing the apparatus to be managed, and an apparatus information which indicates a status of the apparatus to be managed;
a memory section for memorizing the apparatus information in a database; and
a storage control section for creating a plurality of hierarchies structured with upper and lower hierarchies each other in the database based on the host ID and the device ID acquired from the management apparatus and saves the apparatus information into a lower hierarchy.

6. The management system of claim 5,
wherein, the storage control section creates a first hierarchy based on the host ID acquired from the management apparatus, and
creates a second hierarchy which belongs to the first hierarchy relating to the host ID based on the device ID acquired from the management apparatus.

7. The management system of claim 6,
wherein, the storage control section creates the first hierarchy, when the host ID acquired from the management apparatus is not registered in the database.

8. The management system of claim 6,
wherein, the storage control section creates the second hierarchy which belongs to the first hierarchy relating to the host ID, when the device ID acquired from the management apparatus or the apparatus to be managed is not registered in the database.

9. A management method for a management system in which at least one management apparatus and at least one apparatus to be managed are connected via a management server,
wherein the management method comprising:
transmitting a host ID which discerns the management apparatus from the management apparatus to the management server,
creating a first hierarchies based on the host ID acquired from the management apparatus into the database on the management server,
transmitting a device ID which discerns the apparatus to be managed, a host ID of the management apparatus managing the apparatus to be managed, and a apparatus information which indicates a status of the apparatus to be managed from the apparatus to be managed to the management server,
creating a second hierarchy which belongs to the first hierarchy relating to the host ID based on the host ID and device ID acquired from the apparatus to be managed, and
saving the apparatus information into the second hierarchy on the management server.

10. The management method of claim 9,
creating the first hierarchies when the host ID acquired from the management apparatus is not registered in the database.

11. The management method of claim 9,
creating the second hierarchy which belongs to the first hierarchy relating to the host ID when the device ID acquired from the management apparatus or the apparatus to be managed is not registered in the database.

12. A management method for a management system in which at least one management apparatus and at least one apparatus to be managed are connected via a management server,
wherein the management method comprising:
transmitting a host ID which discerns the management apparatus and a device ID which discerns the apparatus to be managed that is managed by the management apparatus, from the management apparatus to the management server,
creating a first hierarchies based on the host ID acquired from the management apparatus,
creating a second hierarchy which belongs to the first hierarchy relating to the host ID based on the host ID and device ID acquired from the management apparatus on the management server,
transmitting the device ID which discerns the apparatus to be managed, the host ID of the management apparatus managing the apparatus to be managed, and an apparatus information which indicates a status of the apparatus to be managed from the apparatus to be managed to the management server, and
saving the apparatus information into the second hierarchy which belongs to the first hierarchy relating to the host ID on the management server.

13. The management method of claim 12,
creating the first hierarchies when the host ID acquired from the management apparatus is not registered in the database.

14. The management method of claim 12,
creating the second hierarchy which belongs to the first hierarchy relating to the host ID when the device ID acquired from the management apparatus or the apparatus to be managed is not registered in the database.

15. A computer readable recording medium storing a program which causes a management server which is connected to at least one management apparatus and at least one apparatus to be managed,
acquiring from the management apparatus, a host ID which discerns the management apparatus,
acquiring from the apparatus to be managed, a device ID which discerns the apparatus to be managed, a host ID of the management apparatus managing the apparatus to be managed, and an apparatus information which indicates a status of the apparatus to be managed,
creating a plurality of hierarchies structured with upper and lower hierarchies each other in the database based on the host ID acquired from the management apparatus and the device ID acquired from the apparatus to be managed, and
saving the apparatus information into a lower hierarchy.

16. The computer readable recording medium storing a program of claim 15,
creating a first hierarchy based on the host ID acquired from the management apparatus, and
creating a second hierarchy which belongs to the first hierarchy relating to the host ID based on the device ID and the host ID acquired from the apparatus to be managed.

17. The computer readable recording medium storing a program of claim 16,
creating the first hierarchy, when the host ID acquired from the management apparatus is not registered in the database.

18. A computer readable recording medium storing a program which causes a management server which is connected to at least one management apparatus and at least one apparatus to be managed,
acquiring from the management apparatus, a host ID which discerns the management apparatus and a device ID which discerns an apparatus to be managed that is managed by the management apparatus,
acquiring from the apparatus to be managed, a device ID which discerns the apparatus to be managed, a host ID of the management apparatus managing the apparatus to be managed, and an apparatus information which indicates a status of the apparatus to be managed,
creating a plurality of hierarchies structured with upper and lower hierarchies each other in the database based on the host ID and the device ID acquired from the management apparatus, and
saving the apparatus information into a lower hierarchy.

19. The computer readable recording medium storing a program of claim 18,
creating first hierarchy based on the host ID acquired from the management apparatus, and
creating second hierarchy which belongs to the first hierarchy relating to the host ID based on the device ID acquired from the management apparatus.

20. The computer readable recording medium storing a program of claim 19,
creating the first hierarchy, when the host ID acquired from the management apparatus is not registered in the database.
